(19) United States
(12) Patent Application Publication
(10) Pub. No.: US 2024/0061815 A1
(43) Pub. Date: Feb. 22, 2024

(54) INTER-SITE REPLICATION TOPOLOGY FOR DIRECTORY SERVICES

(71) Applicant: SAUDI ARABIAN OIL COMPANY, Dhahran (SA)

(72) Inventor: Abdullah Saad ALESSA, Dhahran (SA)

(73) Assignee: SAUDI ARABIAN OIL COMPANY, Dhahran (SA)

(21) Appl. No.: 17/820,486

(22) Filed: Aug. 17, 2022

(51) Int. Cl. G06F 16/182

(52) U.S. Cl. CPC G06F 16/1844

(57) ABSTRACT

The present disclosure relates to systems and/or methods for developing and/or implementing replication topologies for a directory service. For example, various embodiments described herein can relate to a method for developing a robust replication topology that includes designating a master site from a plurality of sites in the replication topology, where the plurality of sites can group multiple computer devices (e.g., multiple servers). Additionally, the method can comprise mapping a plurality of inter-site links between the master site and remaining sites from the plurality of sites. In accordance with various embodiments, mapping the plurality of inter-site links can be performed such that a maximum number of triangular connectivity schemes within the replication topology is achieved.

### FIELD OF THE DISCLOSURE

The technical field relates generally to replication and data management.

### BACKGROUND OF THE DISCLOSURE

Directory services are employed to store information about users, computer devices, and/or data objects (e.g., account credentials) in one or more databases. For example, directory services can be utilized to manage authentication and/or authorization procedures for accessing network resources. For reasons of availability and/or performance, directory services can replicate and distribute databases across a network of servers via a replication mechanism. For example, the replication mechanism can ensure that changes made to a data object on one server is replicated to all other instances of the data object on the other servers of the network. Thereby, the directory service can employ the replication mechanism to keep a distributed database consistent between multiple servers.

Operation of the replication mechanism is typically defined by one or more replication agreements between servers and/or groups of servers, called sites. Further, the replication agreements can be characterized by a replication topology that defines connections and/or replication operations between sites (e.g., to facilitate inter-site replications). Traditionally, the replication topology is manually configured by a subject matter expert with a goal realize the desired replication agreements with the minimal number of connections to reduce network complexity. However, a replication topology defined in said manner can result in replication mechanisms that are prone to delays and/or single points of failure.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a computer-implemented method for developing a replication topology is provided. The method can include designating a master site from a plurality of sites in a replication topology for a directory service. The plurality of sites can comprise groupings of multiple computer devices. The method can also include mapping a plurality of inter-site links between the master site and remaining sites from the plurality of sites. The mapping can maximize a number of triangular connectivity schemes within the replication topology.

In another embodiment, a system for implementing a replication topology is provided. The system can include a memory to store computer executable instructions. The system can also include one or more processors, operatively coupled to the memory, that can execute the computer executable instructions to implement one or more inter-site topology generators configured to designate a master site from a plurality of sites in a replication topology for a directory service. The one or more inter-site topology generators can be further configured to define a plurality of inter-site links between the master site and remaining sites from the plurality of sites. The plurality of sites can comprise groupings of multiple computer devices. Also, the mapping can maximize a number of triangular connectivity schemes within the replication topology.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 illustrates a block diagram of an example, non-limiting system implementing an example replication topology to facilitate an inter-site replication mechanism amongst a network of five sites in accordance with one or more embodiments described herein.

FIG. 2 illustrates a flow diagram of an example, non-limiting computer-implemented method that can be employed to define one or more robust replication topologies in accordance with one or more embodiments described herein.

FIG. 3 illustrates a diagram of an example, non-limiting replication topology during a first stage of development in which inter-site links between a master site and the remaining sites in a system are mapped in accordance with one or more embodiments described herein.

FIG. 4 illustrates a diagram of an example, non-limiting replication topology during a second stage of development in which inter-site links between nearest neighboring sites in a system are mapped in accordance with one or more embodiments described herein.

FIG. 5 illustrates a diagram of an example, non-limiting replication topology during a third stage of development in which inter-site links between next-nearest neighboring sites in a system are mapped in accordance with one or more embodiments described herein.

FIG. 6 illustrates a diagram of an example, non-limiting replication topology that can include multiple types of inter-site links to facilitate one or more replication agreements between eight servers of a system in accordance with one or more embodiments described herein.

FIG. 7 illustrates a block diagram of an example, non-limiting computer environment that can be implemented within one or more systems described herein.

### DETAILED DESCRIPTION

The present disclosure relates generally to defining a replication topology for one or more directory services and, more particularly, to replication topologies comprising multiple triangular connectivity schemes per site to facilitate one or more replication mechanisms.

Embodiments of the present disclosure will now be described in detail with reference to the accompanying figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying figures may vary without departing from the scope of the present disclosure.

As used herein, the term “coupled” or “coupled to” or “connected” or “connected to” or “attached” or “attached to” may indicate establishing either a direct or indirect connection, and is not limited to either unless expressly referenced as such. Wherever possible, like or identical reference numerals are used in the figures to identify common or the same elements. The figures are not necessarily to scale and certain features and certain views of the figures may be shown exaggerated in scale for purposes of clarification.

Embodiments in accordance with the present disclosure comprise systems and/or methods generally related to defining a robust replication topology for executing one or more inter-site replication mechanisms. Various embodiments described herein can include a replication topology that enables the replication mechanism to follow a cyclic route with regards to each respective site. For example, each site in the replication topology can be linked to two or more other sites via one or more triads of inter-site connections; thereby forming a plurality of triangular connectivity schemes. Additionally, the replication topology can comprise multiple types of inter-site links to maximize the number of triangular connectivity schemes for a given number of sites within the system. For instance, a first type of inter-site link can be defined between respective sites and a master site. In another instance, a second type of inter-site link can be defined between nearest neighboring sites. In a further instance, a third type of inter-site link can be defined between next-nearest neighboring sites. Thereby, the replication topologies described herein can comprise multiple inter-site links per site; such that failure, or delay, in an individual site or connection does not result in an impasse of the replication mechanism.

Further, one or more embodiments described herein can constitute one or more technical improvements over conventional replication topologies by establishing robust replication topologies that can minimize replication delays and/or improve consistency amongst the distributed database. For instance, various embodiments described herein can establish inter-site links that enable a cyclic replica flow that can progress, via three or more one-way inter-site links, from a source site to a destination site and back to the source site through a single interim site. Additionally, one or more embodiments described herein can have a practical application by establishing a replication topology that is resistant to failure and/or congestion at any given site of the system. For example, one or more embodiments described herein can control the replica traffic between sites to ensure an accurate and efficient updating of objects within a distributed database. Moreover, due in part to the robust nature of the replication topology described above, various embodiments described herein can execute the one or more replication mechanisms without impasse, even when facing multiple points of failure or congestion within the system.

As used herein, “replication topology” refers to the one or more routes by which replication data (i.e., one or more replicas) travels throughout a network of computer devices. For example, a replication topology can characterize a connectivity scheme between sites of grouped servers (e.g., domain controllers). In various embodiments described herein, a replication topology defines inter-site links by which replica traffic can propagate during one or more replication mechanisms. For instance, the one or more replication mechanisms can utilize multimaster replication, pull replication, store-and-forward replication, and/or state-based replication in accordance with the replication topology to replicate objects between two domain controllers via one or more inter-site links. Repeated executions of the replication mechanism (e.g., across multiple inter-site links) can synchronize one or more distributed databases managed by a directory service application for entire forest of domain controllers.

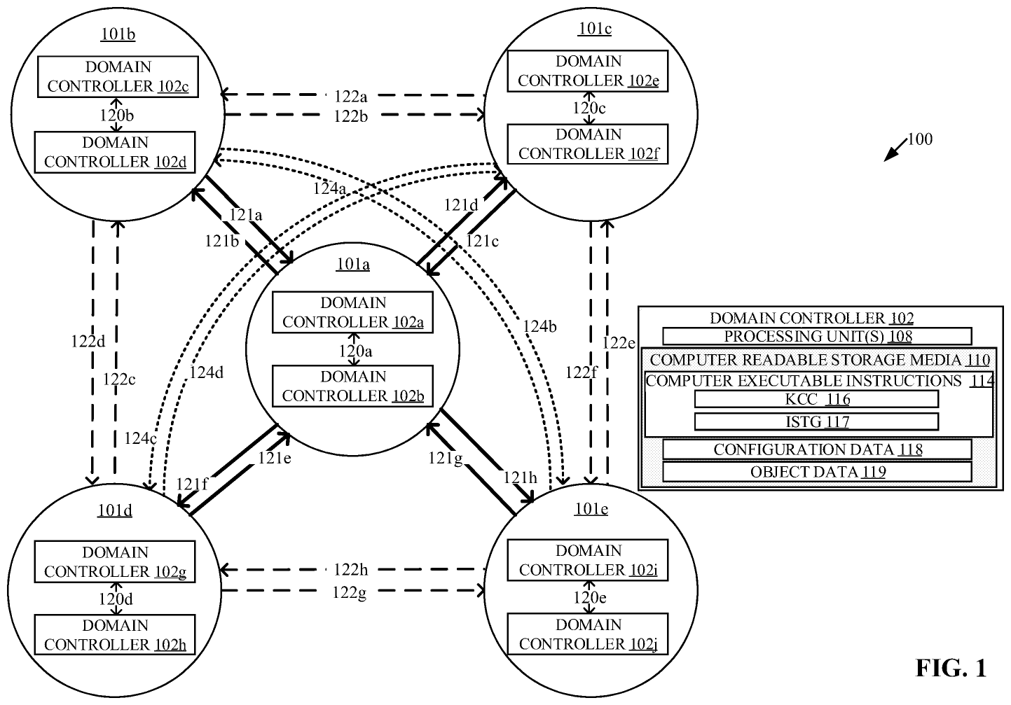

FIG. 1 illustrates a diagram of a non-limiting example of a system 100 that comprises a plurality of sites 101 connected via a robust replication topology in accordance with one or more embodiments described herein. In various embodiments, each site 101 can comprise a set of one or more domain controllers 102. One or more of the domain controllers 102 (e.g., a server, a desktop computer, a laptop, a hand-held computer, a programmable apparatus, a minicomputer, a mainframe computer, an Internet of things (“IoT”) device, and/or the like) in each site 101 can be designated as a bridgehead sever, which can manage replication information and/or database objects in the context of the replication mechanism within the system 100. For example, bridgehead servers can advertise updates to other domain controllers 102 and/or sites 101. As shown in FIG. 1, each domain controller 102 can comprise one or more processing units 108 and/or computer readable storage media 110. In various embodiments, the computer readable storage media 110 can store one or more computer executable instructions 114 that can be executed by the one or more processing units 108 to perform one or more defined functions. In various embodiments, a knowledge consistency checker (“KCC”) 116 and/or inter-site topology generator (“ISTG”) 117 can be computer executable instructions 114 and/or can be hardware components operably coupled to the one or more processing units 108. For instance, in one or more embodiments, the one or more processing units 108 can execute the KCC 116 and/or ISTG 117 to perform various functions described herein (e.g., such as generating and/or mapping replication connection objects). Additionally, the computer readable storage media 110 can store configuration data 118 and/or object data 119.

The one or more processing units 108 can comprise any commercially available processor. For example, the one or more processing units 108 can be a general purpose processor, an application-specific system processor (“ASSIP”), an application-specific instruction set processor (“ASIPs”), or a multiprocessor. For instance, the one or more processing units 108 can comprise a microcontroller, microprocessor, a central processing unit, and/or an embedded processor. In one or more embodiments, the one or more processing units 108 can include electronic circuitry, such as: programmable logic circuitry, field-programmable gate arrays (“FPGA”), programmable logic arrays (“PLA”), an integrated circuit (“IC”), and/or the like.

The one or more computer readable storage media 110 can include, but are not limited to: an electronic storage device, a magnetic storage device, an optical storage device, an electromagnetic storage device, a semiconductor storage device, a combination thereof, and/or the like. For example, the one or more computer readable storage media 110 can comprise: a portable computer diskette, a hard disk, a random access memory (“RAM”) unit, a read-only memory (“ROM”) unit, an erasable programmable read-only memory (“EPROM”) unit, a CD-ROM, a DVD, Blu-ray disc, a memory stick, a combination thereof, and/or the like. The computer readable storage media 110 can employ transitory or non-transitory signals. In one or more embodiments, the computer readable storage media 110 can be tangible and/or non-transitory. In various embodiments, the one or more computer readable storage media 110 can store the one or more computer executable instructions 114 and/or one or more other software applications, such as: a basic input/output system (“BIOS”), an operating system, program modules, executable packages of software, and/or the like.

The one or more computer executable instructions 114 can be program instructions for carrying out one or more operations described herein. For example, the one or more computer executable instructions 114 can be, but are not limited to: assembler instructions, instruction-set architecture (“ISA”) instructions, machine instructions, machine dependent instructions, microcode, firmware instructions, state-setting data, configuration data, source code, object code, a combination thereof, and/or the like. For instance, the one or more computer executable instructions 114 can be written in one or more procedural programming languages. Although FIG. 1 depicts the computer executable instructions 114 stored on computer readable storage media 110, the architecture of the system 100 is not so limited. For example, the one or more computer executable instructions 114 can be embedded in the one or more processing units 108.

In various embodiments, the various domain controllers 102 can implement one or more replication mechanisms to manage updates to one or more databases distributed amongst the sites 101. For example, the object data 119 (e.g., including one or more directory objects) can comprise a portion of the database distributed and/or replicated between multiple sites 101 of the system 100 (e.g., and/or between multiple domain controllers 102 of the sites 101). Database events occurring on a first domain controller 102 can be replicated, via the replication mechanism (e.g., executed via the KCC 116 and/or ISTG 117), to other domain controllers 102 through intra-site and/or inter-site links to maintain consistency of the database within the system 100. Example database events can include additions, deletions, and/or modifications to the object data 119.

The configuration data 118 can define replication topology information that can be employed during the replication operation to direct replica traffic between sites 101 and/or domain controllers 102. For example, the configuration data 118 can include one or more replication connection objects that can define intra-site connections between domain controllers 102 and/or inter-site links between the bridgehead servers (e.g., dynamically designated domain controllers 102) within the multiple sites 101. In various embodiments, the one or more replication connection objects can be manually defined and/or defined via one or more of the computer executable instructions 114. In various embodiments, the replication mechanism implemented by the domain controllers 102 (e.g., via the KCC 116 and/or ISTG 117) can manage replica traffic on a naming context basis, where replication topology information can be held within the configuration data 118 in accordance with standardized naming protocols. For example, the configuration data 118 can include a list of domain controllers 102 that a particular naming context is replicated to (e.g., destination domain controllers 102), and a list of domain controllers 102 that the naming context is replicated from (e.g., source domain controllers 102), which can be bridgeheads designated by the associate site 101. Additionally, the configuration data 118 can include data regarding the location, operational capacity, and/or operational status of the one or more domain controllers 102 and/or sites 101 within the system 100. Further, the configuration data 118 can delineate a schedule according to which the replication mechanism is executed by the domain controllers 102 and/or cost values associated with one or more replication connection objects (e.g., costs associated with one or more inter-site links).

As shown in FIG. 1, each site 101 can comprise a group of domain controllers 102 having an established connectivity via one or more intra-site connections 120, such that each domain controller 102 can communicate directly with the other domain controllers 102 included in the same site 101. For example, domain controllers 102 within a site 101 can communicate across the one or more intra-site connections 120 via high-bandwidth, low-latency remote procedure calls (“RPC”). Additionally, as shown in FIG. 1, the system 100 can comprise a plurality of sites 101 that can be connected together through inter-site links (e.g., low bandwidth, high-latency store-and-forward messaging) characterized by the replication topology. Thereby, replica traffic can extend between computer devices (e.g., servers, such as domain controllers 102) of linked sites 101.

In various embodiments, the KCC 116 of the domain controllers 102 can manage intra-site replication traffic between domain controllers 102. For example, the KCC 116 can define replication connection objects for source and destination replication between domain controllers 102. Further, the ISTG 117 of a designated domain controller 102 can manage the inter-site inbound replication connection objects for a given site 101. For example, the ISTG 117 can generate replication connection objects delineating inter-site links (e.g., master inter-site link 121). For instance, the ISTG 117 can delineate replication routes via one-way inbound connection objects that define links between sites 101 (e.g., from a source domain controller 102 to the domain controller 102 storing the connection object). In another instance, the ISTG 117 can designate a domain controller 102 as the bridgehead server for a given site 101. In various embodiments, multiple bridgehead servers can be designated for a given site 101. In accordance with various embodiments described herein, one or more replication connection objects can be generated via the KCC 116 and/or the ISTG 117 and stored in the configuration data 118. Thus, database events can be replicated by intra-site connections managed by the KCC 116 and/or by inter-site links managed by the ISTG 117, via replication connection objects that can be delineated in the configuration data 118.

In various embodiments, the domain controllers 102 can manage replica traffic flow in accordance with a defined schedule to update database events amongst other domain controllers 102 and/or ensure consistency of the distributed database. Additionally, the schedule can be different for executions employing intra-site connections versus executions employing inter-site links. For example, replicating object data 119 between sites 101 can be more computationally costly than replicating object data 119 between domain controllers 102 of the same site 101. As such, replications between sites 101 can occur less frequently than replications between domain servers 102 of the same site 101. Further, respective inter-site links can have different schedules.

Further, inter-site links may be less available than intra-site connections. For example, inter-site links may be prone to more maintenance and/or may only be active periodically. In one or more embodiments, a given inter-site link between sites 101 can experience periodic accessibility and inaccessibility (e.g., in accordance with a defined schedule or unexpectedly). For instance, the accessibility of one or more inter-site links can be intermittently restricted to reduce computational costs incurred by the system 100. Thus, a replication topology relying on a single inter-site link to traffic replicas to a destination domain controller 102 can be substantially delayed if the inter-site link is inaccessible and/or if the site 101 facilitating the connection to the destination becomes inoperable.

In various embodiments, the configuration data can further include cost values delineating a prioritization amongst inter-site links. For example, inter-site links with lower cost values can receive greater prioritization by the replication mechanism. In one or more embodiments, cost values can be based on one or more parameters of the associated sites 101, such as: the computational capacity associated with one or more of the domain controllers 102; the geographical location of one or more of the domain controllers; the availability of the given inter-site link; resources expended to establish the given inter-site link; user preferences; compliance with data and/or privacy regulations, a combination thereof, and/or the like. In various embodiments, replica traffic can prioritize routes with the lowest sum of cost values, absent a network failure or congestion.

FIG. 1 further depicts an example robust replication topology that can be implemented by the system 100 in accordance with various embodiments described herein. The replication topology is exemplified via five example sites 101 in FIG. 1, where each site 101 comprises two domain controllers 102. For instance, FIG. 1 depicts: a first example site 101a comprising a first domain controller (“1^{st} DC”) 102a operatively coupled to a second domain controller (“2^{nd} DC”) 102b via a first intra-site connection 120a; a second example site 101b comprising a third domain controller (“3^{rd} DC”) 102c operatively coupled to a fourth domain controller (“4^{th} DC”) 102d via a second intra-site connection 120b; a third example site 101c comprising a fifth domain controller (“5^{th} DC”) 102e operatively coupled to a sixth domain controller (“6^{th} DC”) 102f via a third intra-site connection 120c; a fourth example site 101d comprising a seventh domain controller (“7^{th} DC”) 102g operatively coupled to an eighth domain controller (“8^{th} DC”) 102h via a fourth intra-site connection 120d; and a fifth example site 101e comprising a ninth domain controller (“9^{th} DC”) 102i operatively coupled to a tenth domain controller (“10^{th} DC”) 102j via a fifth intra-site connection 120e. While FIG. 1 depicts the system 100 comprising five example sites 101, the architecture of the system 100 is not so limited. For example, embodiments comprising fewer or more sites 101 are also envisaged. Likewise, while FIG. 1 depicts the example sites 101 each comprising two domain controllers 102, embodiments comprising more domain controllers 102 per site 101 are also envisaged.

In various embodiments, each site 101 can designate one or more of its domain controllers 102 as a bridgehead server. For example, Table 1 depicts exemplary bridgehead server designations associated with the example sites 101 shown in FIG. 1.

TABLE 1

| Site 101 | Bridgehead Server |
|---|---|
| 1^{st} Example Site 101a | 1^{st} DC 102a |
| 2^{nd} Example Site 101b | 3^{rd} DC 102c |
| 3^{rd} Example Site 101c | 5^{th} DC 102e |
| 4^{th} Example Site 101d | 7^{th} DC 102g |
| 5^{th} Example Site 101e | 9^{th} DC 102i |

As shown in FIG. 1, the example system 100 can implement a replication topology comprising at least three types of direct inter-site links. Master inter-site links 121 can be inter-site links established between multiple sites 101 and a master site 101. For example, FIG. 1 shows the first example site 101a as the master site 101 of the example replication topology. The master site 101 can be a site 101 linked to each of the other sites 101 of the system 100 via direct master inter-site links 121 (e.g., represented in FIG. 1 by solid, bold arrows). Additionally, the link between the master site 101 and another site 101 can be established via a pair of one-way master inter-site links 121 associated with respective replica traffic directions between the sites 101. For example, Table 2 depicts exemplary master inter-site links 121 associated with the example sites 101 shown in FIG. 1.

TABLE 2

| Master Inter-Site Link 121 | Replication Operation |
|---|---|
| 1^{st} Master Inter-Site Link 121a | 2^{nd} DC 102b pulls replica from 4^{th} DC 102d |
| 2^{nd} Master Inter-Site Link 121b | 3^{rd} DC 102c pulls replica from 1^{st} DC 102a |
| 3^{rd} Master Inter-Site Link 121c | 2^{nd} DC 102b pulls replica from 6^{th} DC 102f |
| 4^{th} Master Inter-Site Link 121d | 5^{th} DC 102e pulls replica from 1^{st} DC 102a |
| 5^{th} Master Inter-Site Link 121e | 2^{nd} DC 102b pulls replica from 8^{th} DC 102h |
| 6^{th} Master Inter-Site Link 121f | 7^{th} DC 102g pulls replica from 1^{st} DC 102a |
| 7^{th} Master Inter-Site Link 121g | 2^{nd} DC 102b pulls replica from 10^{th} DC 102j |
| 8^{th} Master Inter-Site Link 121h | 9^{th} DC 102i pulls replica from 1^{st} DC 102a |

Additionally, nearest neighbor inter-site links 122 can be inter-site links established between sites 101, other than the master site 101, that directly link neighboring sites 101 within the replication topology. The link between nearest neighboring sites 101, other than the master site 101, can be stablished via a pair of nearest neighbor links 122 (e.g., represented in FIG. 1 by dashed arrows), where each respective link is associated with a replica traffic direction between the sites 101. For example, Table 3 depicts exemplary nearest neighbor links 122 associated with the example sites 101 shown in FIG. 1.

TABLE 3

| Nearest Neighbor Inter-Site Link 122 | Replication Operation |
|---|---|
| 1^{st} Nearest Neighbor Inter-Site Link 122a | 4^{th} DC 102d pulls replica from 5^{th} DC 102e |
| 2^{nd} Nearest Neighbor Inter-Site Link 122b | 6^{th} DC 102f pulls replica from 3^{rd} DC 102c |
| 3^{rd} Nearest Neighbor Inter-Site Link 122c | 4^{th} DC 102d pulls replica from 7^{th} DC 102g |
| 4^{th} Nearest Neighbor Inter-Site Link 122d | 8^{th} DC 102h pulls replica from 3^{rd} DC 102c |
| 5^{th} Nearest Neighbor Inter-Site Link 122e | 6^{th} DC 102f pulls replica from 9^{th} DC 102i |
| 6^{th} Nearest Neighbor Inter-Site Link 122f | 10^{th} DC 102j pulls replica from 5^{th} DC 102e |
| 7^{th} Nearest Neighbor Inter-Site Link 122g | 10^{th} DC 102j pulls replica from 7^{th} DC 102g |
| 8^{th} Nearest Neighbor Inter-Site Link 122h | 8^{th} DC 102h pulls replica from 9^{th} DC 102i |

Further, next-nearest neighbor inter-site links 124 can be inter-site links established between far sites 101 that are otherwise connected transitively via at least one interim sites 101 (e.g., where the master site 101 can serve as an interim site 101 between next-nearest neighbors). The inter-site link between next-nearest neighboring sites 101 can be established via a pair of next-nearest neighbor inter-site links 124 (e.g., represented in FIG. 1 by dotted arrows), where each respective link is associated with a replica traffic direction between the sites 101. For example, Table 4 depicts exemplary next-nearest neighbor inter-site links 124 associated with the example sites 101 shown in FIG. 1.

TABLE 4

| Next-Nearest Neighbor Inter-Site Link 124 | Replication Operation |
|---|---|
| 1^{st} Next-Nearest Neighbor Inter-Site Link 124a | 4^{th} DC 102d pulls replica |
| | from 9^{th} DC 102i |
| 2^{nd} Next-Nearest Neighbor Inter-Site Link 124b | 10^{th} DC 102j pulls replica |
| | from 3^{rd} DC 102c |
| 3^{rd} Next-Nearest Neighbor Inter-Site Link 124c | 8^{th} DC 102h pulls replica |
| | from 5^{th} DC 102e |
| 4^{th} Next-Nearest Neighbor Inter-Site Link 124d | 6^{th} DC 102f pulls replica |
| | from 7^{th} DC 102g |

By establishing the three types of inter-site links (e.g., master inter-site link 121, nearest neighbor inter-site link 122, and/or next-nearest neighbor inter-site link 124) each site 101 can be linked to other sites 101 via a plurality of triad connection sets that form a triangular connectivity scheme within the topology. For instance, the second example site 101b can be linked within the replication topology via ten triangular connectivity schemes.

TABLE 5
Second Example Site 101b Connectivity

| Triangular Connectivity Scheme | Participating Sites 101 | Triad Connection Set |
|---|---|---|
| 1^{st} Triangular Connectivity Scheme | 101b, 101a, 101d | 121a, 121f, 122c |
| 2^{nd} Triangular Connectivity Scheme | 101b, 101a, 101d | 122d, 121e, 121b |
| 3^{rd} Triangular Connectivity Scheme | 101b, 101a, 101c | 121a, 121d, 122a |
| 4^{th} Triangular Connectivity Scheme | 101b, 101a, 101c | 122b, 121c, 121b |
| 5^{th} Triangular Connectivity Scheme | 101b, 101a, 101e | 121a, 121h, 124a |
| 6^{th} Triangular Connectivity Scheme | 101b, 101a, 101e | 124b, 121g, 121b |
| 7^{th} Triangular Connectivity Scheme | 101b, 101c, 101e | 122b, 122f, 124a |
| 8^{th} Triangular Connectivity Scheme | 101b, 101c, 101e | 124b, 122e, 122a |
| 9^{th} Triangular Connectivity Scheme | 101b, 101d, 101e | 124b, 122h, 122c |
| 10^{th} Triangular Connectivity Scheme | 101b, 101d, 101e | 122d, 122g, 124a |

Through the plurality of triangular connectivity schemes, the second example site 101b is linked to each of the other example sites 101 either directly or transitively with a plurality of interim site 101 options. Additionally, the plurality of triangular connectivity schemes enable a cyclical replica flow from the second example site 101b to any of the other sites 101, and back to the second example site 101b utilizing a transitive connection via a single interim site 101.

In various embodiments, the master inter-site links 121 can be associated with the lowest cost and/or highest priority amongst the inter-site links, followed by the nearest neighbor inter-site links 122, and then the next-nearest neighbor inter-site links 124. However, where a master inter-site link 121 is experiencing high congestion, and/or the master site 101 is unavailable, one or more of the domain controllers 102 can execute the replication mechanism (e.g., can execute replication pull operations) via one or more of the nearest neighbor inter-site links 122. Further, where a relied upon nearest neighbor inter-site link 122 is experiencing high congestion, and/or the target nearest neighbor site 101 is unavailable, one or more of the domain controllers 102 can execute the replication mechanism (e.g., can execute replication pull operations) via one or more of the next-nearest neighbor inter-site links 124. Thereby, the robust replication topology described herein can provide numerous routes for replica traffic to employ in order to mitigate congestion and/or overcome the unavailability of one or more sites 101.

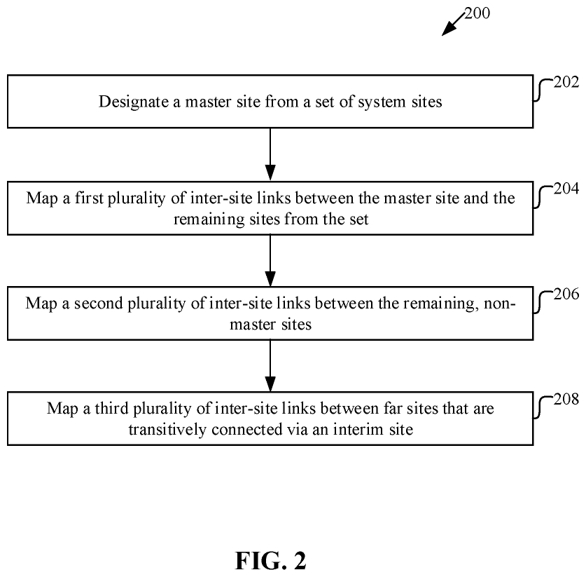

In view of the foregoing structural and functional features described above, example methods regarding the development and/or implementation the replication topology will be better appreciated with reference to FIG. 2. While, for purposes of simplicity of explanation, the example method of FIG. 2 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

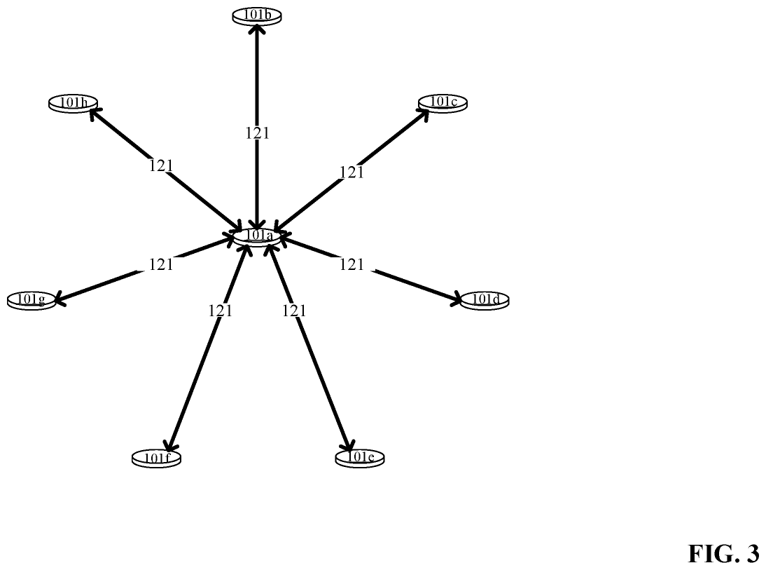

FIG. 2 illustrates a flow diagram of an example, non-limiting method 200 that can be employed to establish a robust replication topology in accordance with one or more embodiments described herein. In various embodiments, method 200 can establish a replication topology comprising a maximum number of triangular connectivity schemes for the given number of sites 101 in a system 100. For example, method 200 can result in a replication topology that facilitates a cyclic replica flow and mitigates impasses in the replication traffic due to the unavailability of one or more linked sites 101 in accordance with the various embodiments described herein. For instance, the method 200 can be employed to define master inter-site links 121, nearest neighbor inter-site links 122, and/or next-nearest neighbor inter-site links 124. In one or more embodiments, the method 200 can be implemented in a system 100 comprising five sites 101 to achieve the example replication topology depicted in FIG. 1. However, the method 200 is not limited to systems 100 comprising five sites 101. Rather, the method 200 can be applied to systems 100 comprising fewer or more sites 101 than five, such as a system 100 comprising eight sites 101 (e.g., as exemplified in FIGS. 3-6).

At 202, the method 200 can comprise designating a master site 101 from a set of system 100 sites 101. In accordance with various embodiments described herein, the system 100 can comprise a plurality of sites 101, each having one or more groups of domain controllers 102. The master site 101 can be designated manually (e.g., via one or more system 100 users) and/or via the system 100 (e.g., via one or more ISTGs 117 and/or processing units 108). In one or more embodiments, a site 101 can be randomly selected to serve as the master site 101. In one or more embodiments, a site 101 can be selected as the master site 101 based on the site's 101 computer resources and/or location within the system 100. For example, a site 101 can be selected as the master site 101 based on the site's 101 hardware components, geographical location, network connectivity, a combination thereof, and/or the like. In various embodiments, a site 101 can be selected as the master site 101 based on one or more default settings and/or user preferences defined by the configuration data 118.

At 204, the method 200 can comprise mapping a first plurality of inter-site links between the master site 101 and the remaining sites 101 of the system 100. For example, the first plurality of inter-site links can be master inter-site links 121, which can establish a direct link between the master site 101 and each other, non-master site 101 in the system 100. In one or more embodiments, the mapping at 204 can be performed by the one or more processing units 108 executing, for instance, the one or more ISTGs 117 (e.g., which can be programmed to generate replication connection objects that delineate master inter-site links 121 in accordance with the various embodiments described herein).

In accordance with various embodiments described herein, each non-master site 101 can be assigned a pair of master-site links 121 (e.g., with each link of the pair delineating a one-way direction of replica traffic) between the respective site 101 and the master site 101. In one or more embodiments, the one or more master inter-site links 121 can be manually set and/or modified by one or more users of the system 100 and/or defined via the one or more ISTGs 117. In one or more embodiments, the one or more master inter-site links 121 can be automatically defined based on replication information included in the configuration data 118 (e.g., such as cost values associated with potential inter-site links). For example, the one or more master inter-site links 121 can be defined via one or more replication connection objects generated by the one or more ISTGs 117 (e.g., in accordance with one or more user settings) and comprised within the configuration data 118. In various embodiments, the one or more master inter-site links 121 can be associated with the lowest cost value (e.g., highest prioritization) amongst the inter-site links.

Where the replication topology is characterized by a planar diagram, the master site 101 can be centrally located in the diagram with the remaining sites 101 equally spaced around the master site 101. For instance, FIG. 1 exemplifies an embodiment of the mapping at 204 with regards to a system 100 comprising five sites 101, where the first example site 101a serves as the master site 101 and is directly linked to each of the remaining four sites 101b-e via master inter-site links 121. Also, FIG. 3 exemplifies another embodiment of the replication topology in which the system 100 comprising eight sites 101. As shown in FIG. 3, the first example site 101a serves as the master site 101 and is directly linked to each of the remaining seven sites 101b-h via master inter-site links 121. For sake of clarity, FIG. 3 depicts pairs of master inter-site links 121 via single solid, bold, double-arrowed lines.

At 206, the method 200 can comprise mapping a second plurality of inter-site links between the remaining, non-master sites 101. For example, the second plurality of inter-site links can be nearest neighbor inter-site links 122, which can establish direct links between non-master sites 101. In accordance with various embodiments described herein, the mapping at 206 can link each non-master site 101 with two other non-master sites 101 by the second plurality of inter-site links (e.g., by the nearest neighbor inter-site links 122).

In one or more embodiments, the mapping at 204 can be performed by the one or more processing units 108 executing, for instance, the one or more ISTGs 117 (e.g., which can be programmed to generate replication connection objects that delineate nearest neighbor inter-site links 122 in accordance with the various embodiments described herein). In one or more embodiments, the one or more nearest neighbor inter-site links 122 can be manually set and/or modified by one or more users of the system 100 and/or defined by the one or more ISTGs 117. Alternatively, the one or more nearest neighbor inter-site links 122 can be automatically defined based on replication information included in the configuration data 118 (e.g., such as cost values associated with potential inter-site links). For example, the one or more nearest neighbor inter-site links 122 can be defined via one or more replication connection objects generated by the one or more ISTGs 117 (e.g., in accordance with one or more user settings) and comprised within the configuration data 118. In various embodiments, the nearest neighbor inter-site links 122 can be associated with the second lowest cost value (e.g., second highest prioritization) amongst the inter-site links.

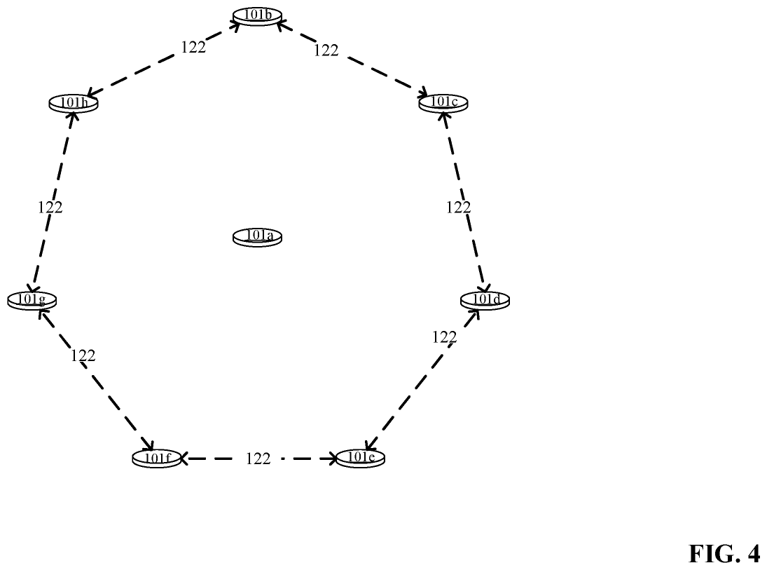

In various embodiments, the mapping at 206 can comprise assigning two distinct pairs of direct inter-site links (e.g., with each link of the pair delineating a one-way direction of replica traffic), in addition to the master inter-site link 121, for each non-master site 101 of the system 100; thereby establishing the nearest neighbor inter-site links 122. For example, the mapping at 206 can link each respective non-master site 101 to two other non-master sites 101 (i.e., the given site's 101 nearest neighbors).

Where the replication topology is represented by a planar diagram, the nearest neighboring sites 101 can be non-master sites 101 positioned adjacent to each other in an equally spaced orientation around the master site 101. FIG. 1 exemplifies an embodiment of the mapping at 206 with regards to a system 100 comprising five sites 101, where example sites 101b-e are non-master sites 101 connected via nearest neighbor links 122. Also, FIG. 4 exemplifies another embodiment of the mapping at 206 in which the each non-master site 101 is linked to two other non-master sites 101. For instance, the second example site 101b is mapped to its nearest neighbors, third example site 101c and eighth example site 101h, via two pairs of nearest neighbor links 122, where each pair of nearest neighbor links 122 is represented by a dashed, double arrowed line in FIG. 4. For clarity, the master inter-site links 121 established via the mapping at 204 are not shown in FIG. 4, which focuses on the mapping at 206.

At 208, the method can comprise mapping a third plurality of inter-site links between far sites 101 that are transitively connected via an interim site 101. For example, the system can comprise five or more sites 101, and the third plurality of inter-site links can be next-nearest neighbor inter-site links 124.

In one or more embodiments, the mapping at 208 can be performed by the one or more processing units 108 executing, for instance, the one or more ISTGs 117 (e.g., which can be programmed to generate replication connection objects that delineate next-nearest neighbor inter-site links 124 in accordance with the various embodiments described herein). In one or more embodiments, the one or more next-nearest neighbor inter-site links 124 can be manually set and/or modified by one or more users of the system 100 and/or defined by the one or more ISTGs 117. Alternatively, the one or more next-nearest inter-site links 124 can be automatically defined based on replication information included in the configuration data 118 (e.g., such as cost values associated with potential inter-site links). For example, the one or more next-nearest neighbor inter-site links 124 can be defined via one or more replication connection objects generated by the one or more ISTGs 117 (e.g., in accordance with one or more user settings) and comprised within the configuration data 118. In one or more embodiments, the next-nearest neighbor inter-site links 124 can be associated with the highest cost value (e.g., lowest prioritization) amongst the inter-site links.

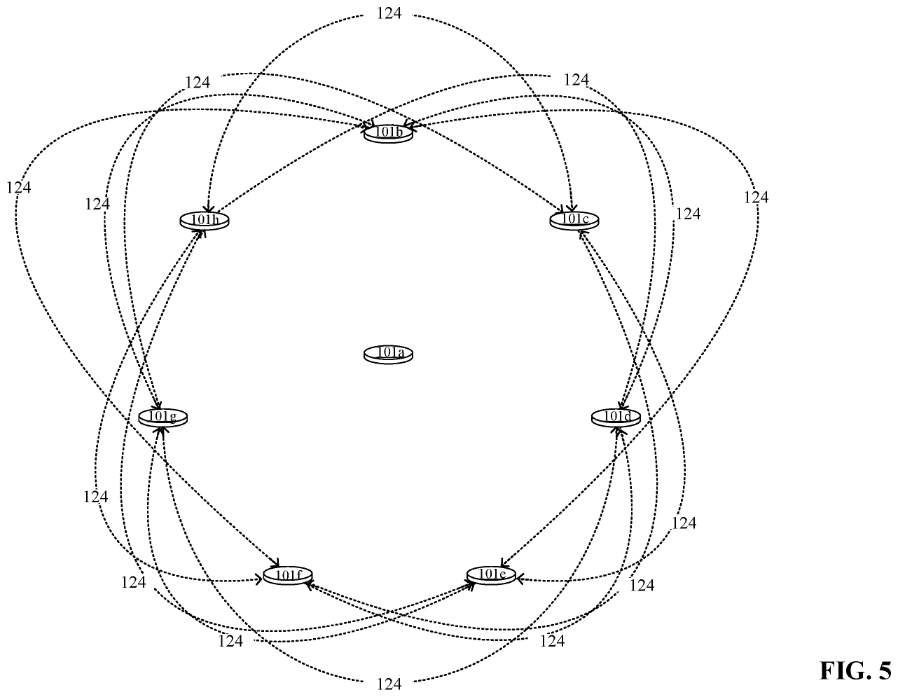

In various embodiments, the far sites 101 mapped at 208 can be next-nearest neighbor sites 101 transitively connected to each other via a single interim site 101 (e.g., where the interim site 101 can be the master site 101 or a nearest neighbor site 101), given the connectivity established by the mapping at 204 and/or 206. For example, sites 101 linked by the mapping at 208 can be sites 101 transitively connected via the master site 101, which are not directly linked via a nearest neighbor link 122. In another example, sites 101 linked by the mapping at 208 can be sites 101 transitively connected via a nearest neighbor site 101.

Where the replication topology is represented by a planar diagram, the next-nearest neighbor sites 101 can be non-master sites 101 that are not adjacent to the given site 101 in the established spacing established above with regards to the mappings at 204 and 206. FIG. 1 exemplifies an embodiment of the mapping at 208 with regards to a system 100 comprising five sites 101, where example sites 101b and 101e are linked via next-nearest neighbor inter-site links 124 and/or example sites 101c and 101d are linked via next-nearest neighbor inter-site links 124. Also, FIG. 5 exemplifies another embodiment of the mapping at 208 in which the each non-master site 101 is linked to its four next-nearest neighbor sites 101. For example, the next-nearest neighbor sites 101 with respect to the seventh example site 101g include: second example site 101b (e.g., transitively connected via its nearest neighbor site 101, the eighth example site 101h, and/or via the master site 101, the first example site 101a), third example site 101c (e.g., transitively connected via the master site 101, the first example site 101a), fourth example site 101d (e.g., transitively connected via the master site 101, the first example site 101a), and fifth example site 101e (e.g., transitively connected via its nearest neighbor site 101, the eighth example site 101h, and/or via the master site 101, the first example site 101a). Each next-nearest neighboring sites 101 shown in FIG. 5 linked via a pair of next-nearest neighbor links 124 (e.g., with each link of the pair associated with a respective replica traffic direction), where each pair of next-nearest neighbor links 124 is represented by a dotted, double arrowed line. For clarity, the master inter-site links 121 and/or the nearest neighbor inter-site links 122 established via the mappings at 204 and/or 206 are not shown in FIG. 5, which focuses on the mapping at 208.

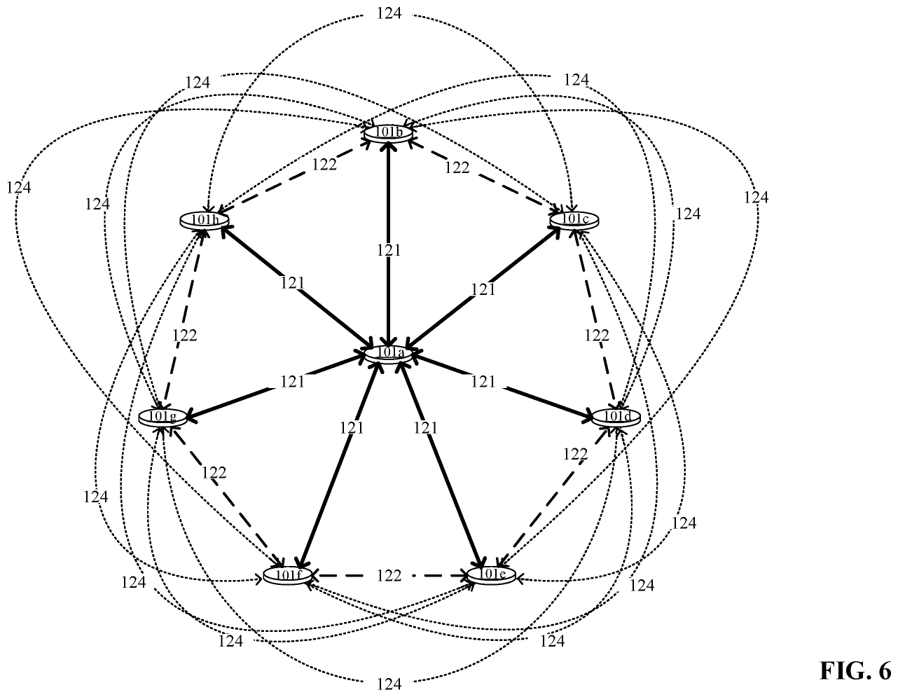

FIG. 6 illustrates a diagram of an example, non-limiting replication topology that can be developed via method 200 in accordance with one or more embodiments described herein. For example, the replication topology depicted in FIG. 6 can be the culmination of the mapping at 204-208, as exemplified in FIGS. 3-5. As shown in FIG. 6, method 200 can achieve a replication topology that maximizes the number of triangular connectivity schemes between sites 101. Additionally, the method 200 can achieve a replication topology that avoids singularly connected sites 101 within the system 100. Further, each site 101 of the replication topology (e.g., exemplified in FIG. 6) can be a part of a cyclic replica flow, in which replica traffic can be directed to a target destination and return to its source within a single interim site 101. Thus, the replication topologies described herein can improve operational efficiency of a network by minimizing replica flow congestion. Example systems that can benefit from the robust replication topology described herein can include, but are not limited to: group policy distribution systems, application/services integrations, workstation systems, server administrative systems, and/or the like.

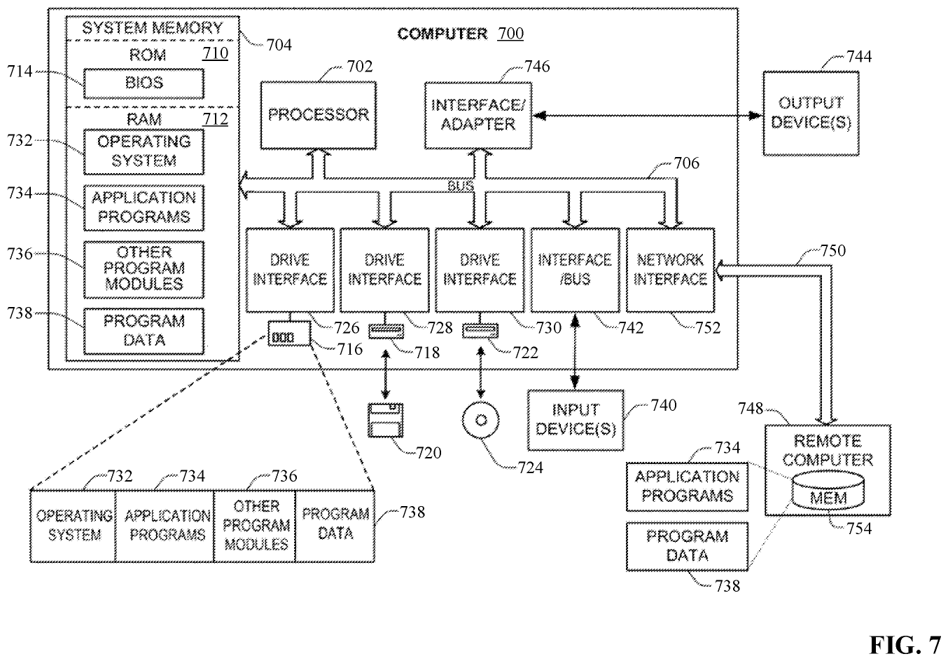

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 7. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 7 illustrates one example of a computer system 700 that can be employed to execute one or more embodiments of the present disclosure. Computer system 700 can be implemented on one or more general purpose networked computer systems, embedded computer systems, routers, switches, server devices, client devices, various intermediate devices/nodes or standalone computer systems. Additionally, computer system 700 can be implemented on various mobile clients such as, for example, a personal digital assistant (PDA), laptop computer, pager, and the like, provided it includes sufficient processing capabilities.

Computer system 700 includes processing unit 702, system memory 704, and system bus 706 that couples various system components, including the system memory 704, to processing unit 702. Dual microprocessors and other multi-processor architectures also can be used as processing unit 702. System bus 706 may be any of several types of bus structure including a memory bus or memory controller, a peripheral bus, and a local bus using any of a variety of bus architectures. System memory 704 includes read only memory (ROM) 710 and random access memory (RAM) 712. A basic input/output system (BIOS) 714 can reside in ROM 710 containing the basic routines that help to transfer information among elements within computer system 700.

Computer system 700 can include a hard disk drive 716, magnetic disk drive 718, e.g., to read from or write to removable disk 720, and an optical disk drive 722, e.g., for reading CD-ROM disk 724 or to read from or write to other optical media. Hard disk drive 716, magnetic disk drive 718, and optical disk drive 722 are connected to system bus 706 by a hard disk drive interface 726, a magnetic disk drive interface 728, and an optical drive interface 730, respectively. The drives and associated computer-readable media provide nonvolatile storage of data, data structures, and computer-executable instructions for computer system 700. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 710, including operating system 732, one or more application programs 734, other program modules 736, and program data 738. In some examples, the application programs 734 can include the KCC 116 and/or ISTG 117, and the program data 738 can include configuration data 118. The application programs 734 and program data 738 can include functions and methods programmed to generate and/or manage replication connection objects that delineate the robust replication topology characteristics described herein such as shown and described herein.

A user may enter commands and information into computer system 700 through one or more input devices 740, such as a pointing device (e.g., a mouse, touch screen), keyboard, microphone, joystick, game pad, scanner, and the like. For instance, the user can employ input device 740 to edit or modify replication connection objects, cost values, and/or replication schedules. These and other input devices 740 are often connected to processing unit 702 through a corresponding port interface 742 that is coupled to the system bus, but may be connected by other interfaces, such as a parallel port, serial port, or universal serial bus (USB). One or more output devices 744 (e.g., display, a monitor, printer, projector, or other type of displaying device) is also connected to system bus 706 via interface 746, such as a video adapter.

Computer system 700 may operate in a networked environment using logical connections to one or more remote computers, such as remote computer 748. Remote computer 748 may be a workstation, computer system, router, peer device, or other common network node, and typically includes many or all the elements described relative to computer system 700. The logical connections, schematically indicated at 750, can include a local area network (LAN) and a wide area network (WAN). When used in a LAN networking environment, computer system 700 can be connected to the local network through a network interface or adapter 752. When used in a WAN networking environment, computer system 700 can include a modem, or can be connected to a communications server on the LAN. The modem, which may be internal or external, can be connected to system bus 706 via an appropriate port interface. In a networked environment, application programs 734 or program data 738 depicted relative to computer system 700, or portions thereof, may be stored in a remote memory storage device 754.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

The invention claimed is:

1. A method, comprising:
designating a master site from a plurality of sites in a replication topology for a directory service, wherein the plurality of sites comprise groupings of multiple computer devices; and
mapping a plurality of inter-site links between the master site and remaining sites from the plurality of sites, wherein the mapping maximizes a number of triangular connectivity schemes within the replication topology.

2. The method of claim 1, wherein the plurality of inter-site links are delineated by replication connection objects generated by an inter-site topology generator, and wherein the replication connection objects delineate one-way inbound replica traffic from a source domain controller to a destination domain controller.

3. The method of claim 1, further comprising:
mapping a second plurality of inter-site links between the remaining sites from the plurality of sites, wherein a second site from the remaining sites is directly linked to a third site and a fourth site from the remaining sites by the second plurality of inter-site links.

4. The method of claim 3, wherein the third site and the fourth site are nearest neighbors to the second site in the replication topology.

5. The method of claim 3, further comprising:
mapping a third plurality of inter-site links between the second site and a fifth site from the remaining sites, wherein the second site and the fifth site are transitively connected via an interim site within the replication topology absent the third plurality of inter-site links.

6. The method of claim 5, wherein the fifth site is a next-nearest neighbor to the second site in the replication topology.

7. The method of claim 5, wherein a first triangular connectivity scheme from the number of triangular connectivity schemes includes the master site, the second site, and the third site connected together by a first inter-site link from the plurality of inter-site links and two second inter-site links from the second plurality of inter-site links.

8. The method of claim 7, wherein a second triangular connectivity scheme from the number of triangular connectivity schemes includes the master site, the second site, and the fifth site connected together by the first inter-site link from the plurality of inter-site links, one of the two second inter-site links from the second plurality of inter-site links, and a third inter-site link from the third plurality of inter-site links.

9. The method of claim 8, wherein the plurality of inter-site links are associated with a first cost value, wherein the second plurality of inter-site links are associated with a second cost value, wherein the third plurality of inter-site links are associated with a third cost value, wherein the first cost value is less than the second cost value, and wherein the second cost value is less than the third cost value.

10. A system, comprising:
memory to store computer executable instructions;
one or more processors, operatively coupled to the memory, that execute the computer executable instructions to implement:
one or more inter-site topology generators configured to designate a master site from a plurality of sites in a replication topology for a directory service and define a plurality of inter-site links between the master site and remaining sites from the plurality of sites, wherein the plurality of sites comprise groupings of multiple computer devices, and wherein the mapping maximizes a number of triangular connectivity schemes within the replication topology.

11. The system of claim 10, wherein the plurality of inter-site links are delineated by replication connection objects that define one-way inbound replica traffic from a source domain controller to a destination domain controller.

12. The system of claim 10, wherein the one or more inter-site topology generators are further configured to define a second plurality of inter-site links between the remaining sites from the plurality of sites, wherein a second site from the remaining sites is directly linked to a third site and a fourth site from the remaining sites by the second plurality of inter-site links.

13. The system of claim 12, wherein the one or more inter-site topology generators are further configured to define a third plurality of inter-site links between the second site and a fifth site from the remaining sites, wherein the second site and the fifth site are transitively connected via an interim site within the replication topology absent the third plurality of inter-site links.

14. The system of claim 13, wherein a first triangular connectivity scheme from the number of triangular connectivity schemes includes the master site, the second site, and the third site connected together by a first inter-site link from the plurality of inter-site links and two second inter-site links from the second plurality of inter-site links.

15. The system of claim 14, wherein a second triangular connectivity scheme from the number of triangular connectivity schemes includes the master site, the second site, and the fifth site connected together by the first inter-site link from the plurality of inter-site links, one of the two second inter-site links from the second plurality of inter-site links, and a third inter-site link from the third plurality of inter-site links.
